(19) United States
(12) Patent Application Publication
(10) Pub. No.: US 2024/0384726 A1
(43) Pub. Date: Nov. 21, 2024

(54) METHOD OF MANUFACTURING ROTOR BLADE OF VACUUM PUMP, ROTOR BLADE OF VACUUM PUMP, AND VACUUM PUMP

(71) Applicant: SHIMADZU CORPORATION, Kyoto (JP)

(72) Inventor: Hiroaki KIMURA, Kyoto (JP)

(73) Assignee: SHIMADZU CORPORATION, Kyoto (JP)

(21) Appl. No.: 18/661,803

(22) Filed: May 13, 2024

(30) Foreign Application Priority Data
May 18, 2023 (JP) 2023-082212

(51) Int. Cl. F04D 29/38; B33Y 10/00; B33Y 40/00; B33Y 80/00; F04D 19/04

(52) U.S. Cl. CPC F04D 29/388; B33Y 40/00; B33Y 80/00; F04D 19/04; B33Y 10/00

(57) ABSTRACT

To manufacture, using a method by material lamination, a rotor blade resistible to stress generated upon high-speed rotation. A method of manufacturing a rotor blade includes, forming, using a first material, a center portion and a first portion of a blade extending from a connection portion between the blade and the center portion by a predetermined length, and forming, using a second material laminated and formed on the first material, a second portion extending from a tip end of the first portion to a tip end of the blade.

This application claims priority under 35 U.S.C. § 119 to Japanese Patent Application No. 2023-82212 filed on May 18, 2023. The entire disclosure of Japanese Patent Application No. 2023-82212 is hereby incorporated herein by reference.

### BACKGROUND OF THE INVENTION

### 1. Technical Field

The present invention relates to a method of manufacturing a rotor blade of a vacuum pump, a rotor blade of a vacuum pump, and a vacuum pump.

### 2. Background Art

There has been a vacuum pump including a rotor blade provided in a rotor to be rotationally driven (see, for example, JP-A-2021-139361). In this vacuum pump, the rotor blade is rotated by rotation of the rotor to suck gas from the inside of a pumping target device, and the sucked gas is pumped out. The rotor blade has a center portion which is the center of rotation and a blade radially extending from the center portion.

### SUMMARY OF THE INVENTION

Typically, the rotor blade of the vacuum pump has been manufactured by cutting (shaving) of a metal ingot (e.g., casted material). In manufacturing of the rotor blade by cutting, there are problems that shavings are caused and a processing time is long due to a complicated shape of the rotor blade. In order to solve these problems, it is conceivable to manufacture the rotor blade using a molding method (for example, additive manufacturing) by material lamination. In the molding method by material lamination, material layers are sequentially laminated on each other so that a target having an arbitrary shape can be formed at high speed.

Meanwhile, the rotor blade of the vacuum pump rotates at high speed, and for this reason, great stress is generated on the rotor blade. There is a probability that the rotor blade formed by the molding method by material lamination is not resistible to such stress. This is because the layers of, e.g., a powder material are laminated to form the target in the molding method by material lamination and the rotor blade formed by this method tends to have a lower strength as compared to the rotor blade formed by cutting of the metal ingot.

Thus, an object of the present invention is to manufacture, using a method by material lamination, a rotor blade resistible to stress generated upon high-speed rotation.

A method of manufacturing a rotor blade according to one aspect of the present invention is a method of manufacturing a rotor blade having a center portion and a blade radially extending from the center portion. The method of manufacturing the rotor blade comprising:
forming, using a first material, the center portion and a first portion, the first portion being a portion of the blade extending from a connection portion between the blade and the center portion by a predetermined length; and
forming, using a second material laminated and formed on the first material, a second portion extending from a tip end of the first portion to a tip end of the blade.

In a rotor blade used for a vacuum pump, great stress is generated particularly at a connection portion between a center portion and a blade. For this reason, in the method of manufacturing the rotor blade according to one aspect of the present invention as described above, the center portion and first portion of the rotor blade are formed using the same first material. That is, the center portion, the connection portion between the center portion and the blade, and the first portion of the blade extending from the connection portion are formed using the same first material. On the other hand, the remaining portion of the blade, i.e., the second portion extending from the tip end of the first portion to the tip end of the blade, is formed using the second material laminated and formed on the first material. Thus, in the rotor blade obtained by the above-described manufacturing method, the second portion made of the second material does not include the connection portion between the center portion and the blade, at which particularly great stress is generated. Since the location at which the particularly great stress is generated is not made of the second material formed by a method by material lamination, the rotor blade resistible to stress generated upon high-speed rotation can be manufactured using the method by material lamination. As a result, the rotor blade having sufficient strength can be manufactured while taking advantage of the method by material lamination.

### BRIEF DESCRIPTION OF THE DRAWINGS

FIG. 1 is a sectional view of a vacuum pump;

FIG. 2 is a top view of a rotor blade;

FIG. 3 is a flowchart showing a first manufacturing method of the rotor blade;

FIG. 4A is a view schematically showing the first manufacturing method of the rotor blade;

FIG. 4B is a view schematically showing the first manufacturing method of the rotor blade;

FIG. 4C is a view schematically showing the first manufacturing method of the rotor blade;

FIG. 5 is a flowchart showing a second manufacturing method of the rotor blade;

FIG. 6A is a view schematically showing the second manufacturing method of the rotor blade;

FIG. 6B is a view schematically showing the second manufacturing method of the rotor blade; and

FIG. 6C is a view schematically showing the second manufacturing method of the rotor blade.

### DETAILED DESCRIPTION OF THE EXEMPLARY EMBODIMENTS

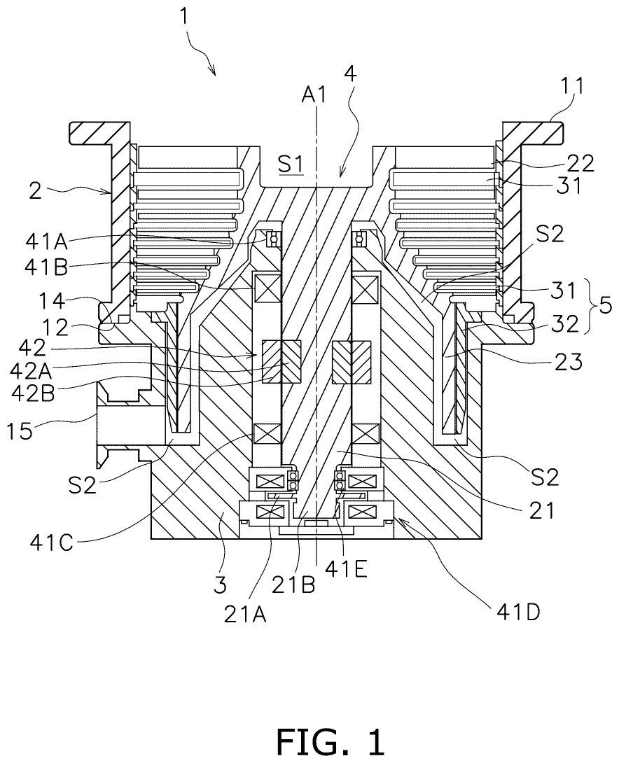

Hereinafter, a rotor blade used for a vacuum pump and a method of manufacturing the rotor blade will be described. First, the vacuum pump including the rotor blade will be described with reference to FIG. 1. FIG. 1 is a sectional view of a vacuum pump 1. The vacuum pump 1 includes a housing 2, a base 3, a rotor 4, and a stator 5.

The housing 2 includes a first end portion 11, a second end portion 12, and a first internal space S1. The first end portion 11 is provided with a suction port 13. The suction port 13 is connected to the inside of a pumping target device so that gas can flow therebetween. The first internal space S1 communicates with the suction port 13. The second end portion 12 is positioned opposite to the first end portion 11 in the axial direction (hereinafter merely referred to as an “axial direction A1”) of the rotor 4. The second end portion 12 is connected to the base 3. The base 3 includes a base end portion 14. The base end portion 14 is connected to the second end portion 12 of the housing 2. The base 3 is, for example, an aluminum member.

The rotor 4 is housed in an internal space of the housing 2. The rotor 4 includes a shaft 21. The shaft 21 extends in the axial direction A1. The shaft 21 is rotatably housed in the base 3. A lower portion of the shaft 21 is provided with a thrust disc 21A. Further, a target 21B is screwed to the lower end of the shaft 21.

The rotor 4 includes plural stages of rotor blades 22 and a rotor cylindrical portion 23. Each of the plural stages of rotor blades 22 is connected to the shaft 21 with inclined with respect to the axial direction A1. The plurality of rotor blades 22 is arranged at intervals in the axial direction A1. The plural stages of rotor blades 22 radially extend about the shaft 21. Note that in the figure, a reference numeral is assigned only to one of the plural stages of rotor blades 22 and no reference numerals are assigned to the other rotor blades 22. The rotor cylindrical portion 23 is arranged below the plural stages of rotor blades 22. The rotor cylindrical portion 23 extends in the axial direction A1.

The stator 5 is arranged on the outer peripheral side of the rotor 4. The stator 5 includes plural stages of stator blades 31 and a stator cylindrical portion 32. Each of the plural stages of stator blades 31 is connected to the inner surface of the housing 2 with inclined in a direction opposite to the inclination of the rotor blade 22. For example, in a case where the rotor blade 22 is inclined from a suction side to an exhaust side, the stator blade 31 is inclined from the exhaust side to the suction side. On the other hand, in a case where the rotor blade 22 is inclined from the exhaust side to the suction side, the stator blade 31 is inclined from the suction side to the exhaust side. The inclination directions of the rotor blade 22 and the stator blade 31 can be determined as necessary according to, e.g., the rotation direction of the rotor 4.

The plural stages of stator blades 31 are arranged at intervals in the axial direction A1. Each of the plural stages of stator blades 31 is arranged between adjacent ones of the plural stages of rotor blades 22. The plural stages of stator blades 31 radially extend about the shaft 21. Note that in the figure, reference numerals are assigned only to two of the plural stages of stator blades 31 and no reference numerals are assigned to the other stator blades 31. The stator cylindrical portion 32 is fixed in contact with the base 3. In the radial direction of the rotor cylindrical portion 23, the stator cylindrical portion 32 is arranged so as to face the outer peripheral surface of the rotor cylindrical portion 23 through a slight clearance. The inner peripheral surface of the stator cylindrical portion 32 facing the rotor cylindrical portion 23 is provided with a spiral groove.

As shown in FIG. 1, an exhaust space S2 is formed further on a downstream side with respect to exhaust-downstream-side end portions of the rotor cylindrical portion 23 and the stator cylindrical portion 32. Pumping target gas pumped from the pumping target device is guided into the exhaust space S2. The exhaust space S2 communicates with an exhaust port 15. The exhaust port 15 is provided at the base 3. Another vacuum pump is connected to the exhaust port 15. Note that the exhaust downstream side indicates a side closer to the exhaust space S2 in the axial direction A1. Moreover, an exhaust downstream direction indicates a direction toward the exhaust space S2.

The vacuum pump 1 includes bearings 41A, 41E, magnetic bearings 41B to 41D, and a motor 42. The bearings 41A, 41E are attached to a position of the base 3 where the shaft 21 is housed. The bearings 41A, 41E rotatably support the shaft 21. The bearings 41A, 41E are ball bearings. The magnetic bearings 41B to 41D are bearings supporting the shaft 21 by magnetic force. Of these bearings, the magnetic bearings 41B, 41C are radial magnetic bearings supporting the shaft 21 in the radial direction. The magnetic bearing 41D is a thrust magnetic bearing supporting the shaft 21 in the axial direction.

The motor 42 rotationally drives the rotor 4. The motor 42 includes a motor rotor 42A and a motor stator 42B. The motor rotor 42A is attached to the shaft 21. The motor stator 42B is attached to the base 3. The motor stator 42B is arranged so as to face the motor rotor 42A.

In the vacuum pump 1, the plural stages of rotor blades 22 and the plural stages of stator blades 31 form a turbo-molecular pump portion. The rotor cylindrical portion 23 and the stator cylindrical portion 32 form a screw groove pump portion. In the vacuum pump 1, the rotor 4 is rotated by the motor 42, and accordingly, the pumping target gas flows into the first internal space S1 from the inside of the pumping target device through the suction port 13. The pumping target gas in the first internal space S1 passes through the turbo-molecular pump portion and the screw groove pump portion, and is guided into the exhaust space S2. The pumping target gas in the exhaust space S2 is pumped out through the exhaust port 15. As a result, the inside of the pumping target device attached to the suction port 13 is brought into a high vacuum state.

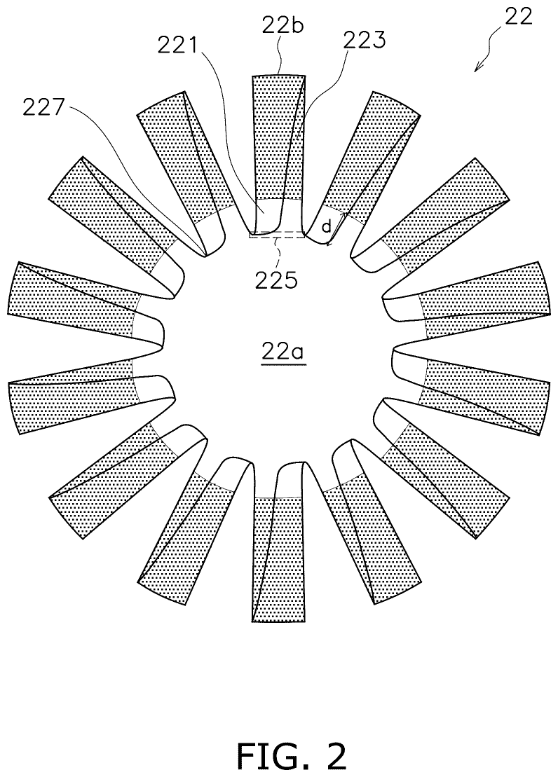

Hereinafter, the rotor blade 22 will be described in detail with reference to FIG. 2. FIG. 2 is a top view of the rotor blade 22. The rotor blade 22 has a center portion 22a and blades 22b. The center portion 22a is a portion at the center of rotation of the rotor blade 22. The rotor blade 22 is arranged on the rotor 4 in such a manner that the center portion 22a is attached to the rotor 4.

The blades 22b radially extend from the side surface of the center portion 22a. The blade 22b is inclined with respect to the thickness direction of the center portion 22a. The blades 22b move, by rotation of the rotor 4, the pumping target gas in a direction toward the exhaust port 15.

The blade 22b has a first portion 221 and a second portion 223. The first portion 221 is a portion of the blade 22b including a connection portion 225 between the center portion 22a and the blade 22b. The first portion 221 is formed integrally with the center portion 22a. Specifically, the first portion 221 is formed together with the center portion 22a in such a manner that one first material M1 is cut. The first material M1 is, for example, a metal casted material such as aluminum.

As shown in FIG. 2, the first portion 221 extends from the connection portion 225 by a predetermined length d. The predetermined length d is determined based on the size of an area where a predetermined level of stress or more is generated at the connection portion 225. The predetermined level can be determined based on, e.g., stress (e.g., shearing stress) resistible by the material (i.e., first material M1) forming the center portion 22a and the first portion 221.

The inventor(s) of the present invention has conducted analysis on the distribution of stress generated at the rotor blade 22 upon high-speed rotation. Through the analysis, the inventor(s) has found that upon high-speed rotation, particularly great stress which is the predetermined level of stress or more is generated at a curved portion 227 formed at the connection portion 225 between the center portion 22a and the blade 22b. Based on such an analysis result, the predetermined length d of the first portion 221 can be determined as such a length that at least the entirety of the curved portion 227 is included in the first portion 221. As described above, the center portion 22a and the first portion 221 are integrally formed and the portion (i.e., curved portion 227) of the connection portion 225 at which the particularly great stress is generated is included in the first portion 221, and therefore, arrangement of a component connection portion and a material changing portion at the portion at which the particularly great stress is generated can be avoided.

The second portion 223 is a remaining portion of the blade 22b other than the first portion 221. That is, the second portion 223 is a portion from the tip end of the first portion 221 to the tip end of the blade 22b. Although details will be described later, the second portion 223 is made of a second material M2 different from the first material M1, which forms the center portion 22a and the first portion 221, in properties. The second material M2 is laminated and formed on the first material M1 forming the center portion 22a and the first portion 221.

The second material M2 forming the second portion 223 is, for example, aluminum, magnesium, or plastic formed by a method (e.g., additive manufacturing) by material lamination. The second material M2 has a smaller specific weight than the specific weight of the first material M1 which is a metal ingot. With this configuration, the weight of the entirety of the blade 22b can be decreased as compared to a case of forming the entirety of the blade 22b using only the first material M1. As a result, the level of the stress generated at the connection portion 225 (particularly, curved portion 227) between the center portion 22a and the blade 22b upon high-speed rotation can be decreased, and the rotor blade 22 more resistible to high-speed rotation can be provided.

The second material M2 formed as described above has a lower strength than that of the first material M1 in some cases. Specifically, the 0.2% proof stress of the second material M2 is lower than the 0.2% proof stress of the first material M1. Note that the “0.2% proof stress” indicates a stress when a strain reaches 0.2%.

As shown in FIG. 2, the portion (i.e., connection portion 225) at which the great stress is generated upon high-speed rotation is included in the first portion 221, and is not included in the second portion 223. Moreover, the first portion 221 and the second portion 223 are not connected to each other through the connection portion 225 where the great stress is generated upon high-speed rotation. With this configuration, even if the second portion 223 is formed using the second material M2 having a lower strength than that of the first material M1, the second portion 223 and/or a connection portion between the first portion 221 and the second portion 223 are not damaged upon high-speed rotation. As described above, the portion at which the great stress is generated upon high-speed rotation is included in the first portion 221 made of the first material M1, and therefore, the rotor blade 22 resistible to high-speed rotation can be provided. Moreover, the second portion 223 can be made of the second material M2 having a lower strength than that of the first material M1, and therefore, the degree of freedom in selection of the second material M2 used for forming the second portion 223 can be enhanced.

Hereinafter, a method of manufacturing the rotor blade 22 having the above-described configuration will be described. As described below, the method of manufacturing the rotor blade 22 includes two types of methods which are a “first manufacturing method” and a “second manufacturing method.” Hereinafter, each manufacturing method will be described in detail.

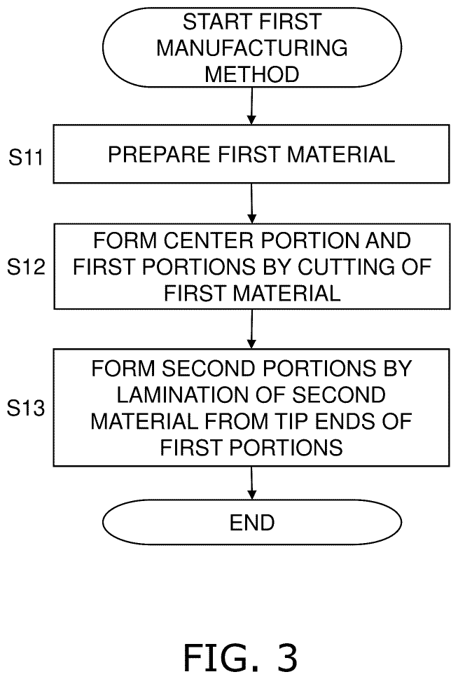

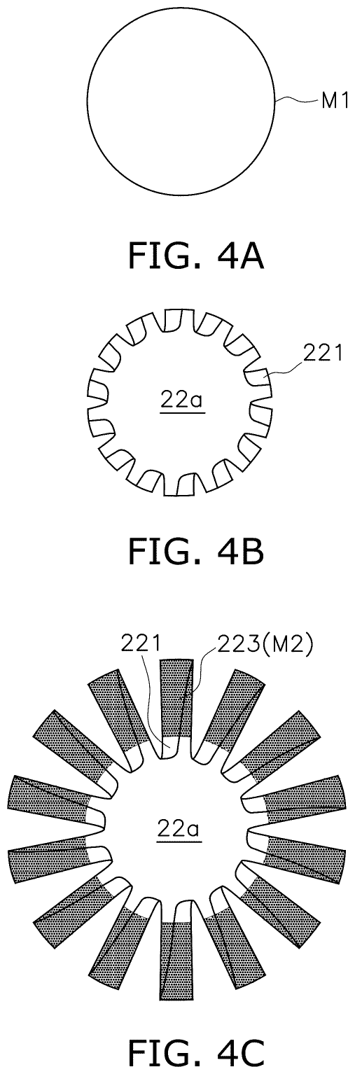

First, the first manufacturing method of the rotor blade 22 will be described with reference to FIGS. 3 and 4A to 4C. FIG. 3 is a flowchart showing the first manufacturing method of the rotor blade 22. FIGS. 4A to 4C are views schematically showing the first manufacturing method of the rotor blade 22. In the first manufacturing method, the center portion 22a and the first portions 221 are formed using the first material M1, and thereafter, the second portions 223 are formed in such a manner that the second material M2 is laminated on the first portions 221. Specifically, the rotor blade 22 is manufactured as follows.

First, the first material M1 for forming the center portion 22a and the first portions 221 is prepared (Step S11). The first material M1 is, for example, a metal casted material such as aluminum. As shown in FIG. 4A, the first material M1 can be in a circular shape having a radius equivalent to a distance from the center of the center portion 22a to the tip end of the first portion 221. However, the present invention is not limited to above, and the shape of the first material M1 can be in other shapes such as a quadrangular shape.

Next, the center portion 22a and the first portions 221 are formed using the first material M1 prepared in Step S11 (Step S12). Specifically, the first material M1 is cut in accordance with the shapes of the center portion 22a and the first portion 221 as shown in FIG. 4B, and in this manner, the center portion 22a and the first portions 221 are formed.

After formation of the center portion 22a and the first portions 221, the second portions 223 are formed from the tip ends of the first portions 221 formed by cutting in such a manner that the second material M2 is laminated in accordance with the shape of the second portion 223, as shown in FIG. 4C (Step S13).

The second portion 223 can be formed in such a manner that the second material M2 is laminated from the tip end of the first portion 221 by additive manufacturing. Specifically, for example, raw powder of the second material M2 is arranged on a portion to be formed as the second portion 223, and is melted and solidified by irradiation of the raw powder with, e.g., a laser beam and/or an electron beam. This process is repeated in accordance with the shape of the second portion 223, and in this manner, the second portion 223 can be formed. Alternatively, for example, the second portion 223 can be formed in such a manner that a process of laminating and solidifying a molten raw material of the second material M2 is repeated in accordance with the shape of the second portion 223. The second portion 223 is formed by additive manufacturing as described above, and therefore, the second portion 223 can be easily formed.

In the above-described first manufacturing method, material cutting is not required for forming the second portion 223, and therefore, shavings are reduced and a processing time is shortened as compared to a case of forming the entirety of the rotor blade 22 by cutting. That is, in the above-described first manufacturing method, material waste due to manufacturing of the rotor blade 22 can be reduced and a manufacturing time for the rotor blade 22 can be shortened as compared to a case of forming the entirety of the rotor blade 22 by cutting.

Moreover, in the first manufacturing method, a difficulty in manufacturing the rotor blade 22 can be lowered as compared to a case of forming the entirety of the rotor blade 22 by cutting. In a case of forming the entirety of the rotor blade 22 by cutting, when the connection portion 225 (particularly, curved portion 227) between the center portion 22a and the blade 22b is processed, such processing needs to be performed with a tool inserted into between two long blades 22b. On the other hand, the first portion 221 is part of the blade 22b, and has a short length. Thus, in the above-described first manufacturing method, when the connection portion 225 is processed, the processing is performed with the tool inserted into between the short first portions 221, and therefore, a difficulty in the processing is lower.

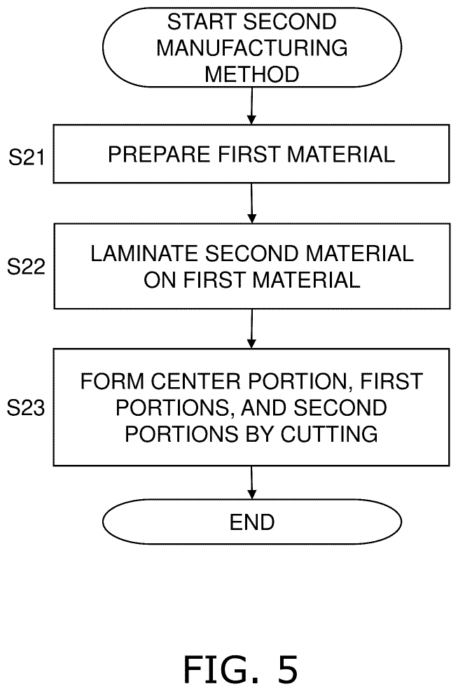

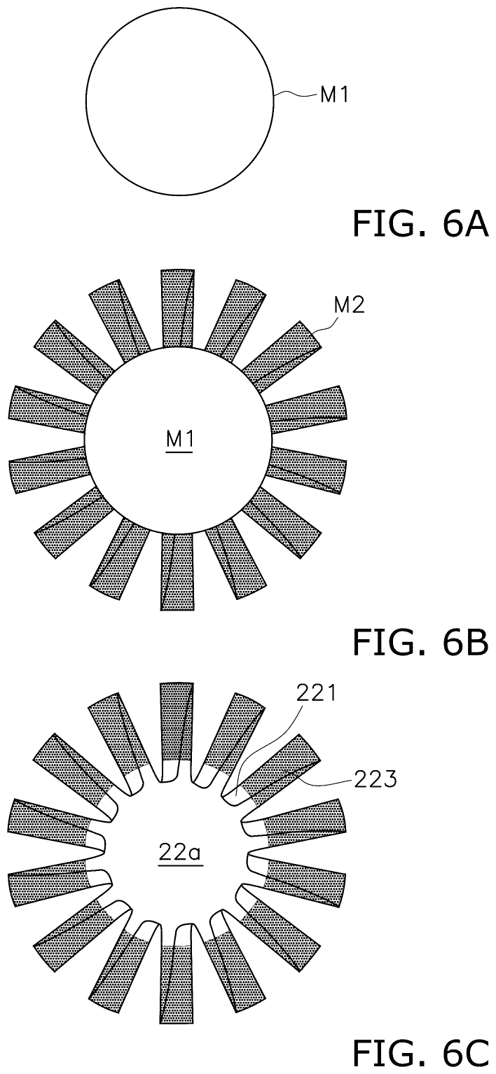

Next, the second manufacturing method of the rotor blade 22 will be described with reference to FIGS. 5 and 6A to 6C. FIG. 5 is a flowchart showing the second manufacturing method of the rotor blade 22. FIGS. 6A to 6C are views schematically showing the second manufacturing method for the rotor blade 22. In the second manufacturing method, the second material M2 forming the second portions 223 is laminated and formed on the first material M1 forming the center portion 22a and the first portions 221, and the center portion 22a, the first portions 221, and the second portions 223 are formed by cutting. Specifically, the rotor blade 22 is manufactured as follows.

First, as shown in FIG. 6A, the first material M1 for forming the center portion 22a and the first portions 221 is prepared (Step S21). Next, as shown in FIG. 6B, the second material M2 is laminated and formed on locations corresponding to the first portions 221 on the first material M1 prepared in Step S21 (Step S22).

The second material M2 can be formed by additive manufacturing. Specifically, for example, the raw powder of the second material M2 is arranged on the locations corresponding to the first portions 221 on the first material M1, and is melted and solidified by irradiation of the raw powder with, e.g., a laser beam and/or an electron beam. This process is repeated, and in this manner, the second material M2 can be formed. Alternatively, for example, the second material M2 can be formed in such a manner that a process of laminating and solidifying the molten raw material of the second material M2 is repeated.

The second material M2 formed in Step S22 does not necessarily have the precise shape of the second portion 223. As described later, the second portions 223 are formed by cutting of the second material M2. Thus, it is sufficient that the second material M2 formed in Step S22 has, for example, the outline shape of the second portion 223 larger than the second portion 223. Alternatively, the second material M2 may be in a rectangular shape or a rectangular parallelepiped shape larger than the second portion 223. The second material M2 may be formed partially overlapping with the tip ends of the first portions 221.

After lamination and formation of the second material M2 on the first material M1, the first material M1 and the second material M2 are cut, and in this manner, the center portion 22a, the first portions 221, and the second portions 223 (i.e., the entirety of the rotor blade 22) are formed as shown in FIG. 6C (Step S23). The first material M1 is cut into the center portion 22a and the first portions 221, and the second material M2 is cut into the second portions 223.

In the above-described second manufacturing method, the entirety of the rotor blade 22 is formed by cutting after formation of the first material M1 and the second material M2, and therefore, the shape and surface condition of the rotor blade 22 configured such that part of each blade 22b is made of the materials having different properties can be precisely adjusted. For example, even in a case where the shape of the second material M2 cannot be precisely controlled when the second material M2 is laminated and formed, the rotor blade 22 having an optimal shape and/or an optimal surface condition can be manufactured. As a result, the rotor blade 22 more suitable for high-speed rotation can be manufactured.

Moreover, in the above-described second manufacturing method, the second material M2 laminated and formed on the first material M1 has at least the outline shape of the second portion 223, and therefore, the amount of cutting work for forming the second portions 223 can be reduced. As a result, shavings are reduced and a processing time is shortened as compared to a case of manufacturing the entirety of the rotor blade 22 from one metal ingot only by cutting. That is, in the above-described second manufacturing method, material waste due to manufacturing of the rotor blade 22 can be reduced and a manufacturing time for the rotor blade 22 can be shortened as compared to a case of forming the entirety of the rotor blade 22 by cutting.

One embodiment of the present invention has been described above, but the present invention is not limited to the above-described embodiment and various changes can be made without departing from the gist of the invention.

The vacuum pump 1 according to the above-described embodiment is the pump configured such that the turbo-molecular pump formed by the plural stages of rotor blades 22 and the plural stages of stator blades 31 and the screw groove pump formed by the rotor cylindrical portion 23 and the stator cylindrical portion 32 are integrated. However, the screw groove pump may be omitted.

Those skilled in the art understand that the above-described plurality of exemplary embodiments is specific examples of the following aspects.

(First Aspect) A method of manufacturing a rotor blade having a center portion and a blade radially extending from the center portion includes:
forming, using a first material, the center portion and a first portion, the first portion being a portion of the blade extending from a connection portion between the blade and the center portion by a predetermined length; and
forming, using a second material laminated and formed on the first material, a second portion extending from a tip end of the first portion to a tip end of the blade.

In the method of manufacturing the rotor blade according to the first aspect, the center portion and first portion of the rotor blade are formed using the same first material. That is, the center portion, the connection portion between the center portion and the blade, and the first portion of the blade extending from the connection portion are formed using the same first material. On the other hand, the remaining portion of the blade, i.e., the second portion extending from the tip end of the first portion to the tip end of the blade, is formed using the second material laminated and formed on the first material. Thus, in the rotor blade obtained by the manufacturing method according to the first aspect, the second portion made of the second material does not include the connection portion between the center portion and the blade, at which particularly great stress is generated. Since the location at which the particularly great stress is generated is not made of the second material formed by a method by material lamination, the rotor blade resistible to stress generated upon high-speed rotation can be manufactured using the method by material lamination. As a result, the rotor blade having sufficient strength can be manufactured while taking advantage of the method by material lamination.

(Second Aspect) The method of manufacturing the rotor blade according to the first aspect may further include:
laminating and forming the second material at a location corresponding to the first portion on the first material; and
forming the center portion and the first portion by cutting the first material and forming the second portion by cutting the second material.

In the manufacturing method according to the second aspect, the entirety of the rotor blade is formed after formation of the first material and the second material, and therefore, the shape and surface condition of the rotor blade configured such that part of the blade is made of the materials having different properties can be precisely adjusted and the rotor blade having an optimal shape and/or an optimal surface condition can be manufactured. As a result, the rotor blade more suitable for high-speed rotation can be manufactured. Moreover, material waste due to manufacturing of the rotor blade can be reduced, and a manufacturing time for the rotor blade can be shortened.

(Third Aspect) The method of manufacturing the rotor blade according to the first aspect may further include:
forming the center portion and the first portion by cutting the first material; and
laminating and forming the second portion made of the second material from the tip end of the first portion formed by cutting.

In the manufacturing method according to the third aspect, material cutting is not required for forming the second portion, and therefore, the material waste due to manufacturing of the rotor blade can be reduced and the manufacturing time for the rotor blade can be shortened as compared to a case of forming the entirety of the rotor blade by cutting. Moreover, a difficulty in manufacturing the rotor blade can be lowered as compared to a case of forming the entirety of the rotor blade by cutting.

(Fourth Aspect) In the method of manufacturing the rotor blade according to any one of the first to third aspects, the predetermined length of the first portion may be determined based on the size of an area where a predetermined level of stress or more is generated at the connection portion. In the manufacturing method according to the fourth aspect, the portion of the connection portion at which great stress is generated can be included in the first portion, and therefore, arrangement of a component connection portion and a material changing portion at the portion at which the great stress is generated can be avoided.

(Fifth Aspect) In the method of manufacturing the rotor blade according to any one of the first to fourth aspects, the second material may be laminated on the first material by additive manufacturing. In the manufacturing method according to the fifth aspect, the second material can be laminated and formed on the first material by a simple method.

(Sixth Aspect) A rotor blade of a vacuum pump according to the sixth aspect includes a center portion and a blade radially extending from the center portion. In this rotor blade, the blade has a first portion and a second portion. The first portion is a portion extending from a connection portion between the blade and the center portion by a predetermined length. The second portion is a portion extending from a tip end of the first portion to a tip end of the blade. The center portion and the above-described first portion are made of a first material. The second portion is made of a second material having a smaller specific weight than that of the first material.

In the rotor blade of the vacuum pump according to the sixth aspect, the center portion and first portion of the rotor blade are made of the same first material. That is, the center portion, the connection portion between the center portion and the blade, and the first portion of the blade extending from the connection portion are formed using the same first material. On the other hand, the remaining portion of the blade, i.e., the second portion extending from the tip end of the first portion to the tip end of the blade, is formed using the second material different from the first material. Thus, in the rotor blade according to the sixth aspect, the second portion made of the second material does not include the connection portion between the center portion and the blade, at which great stress is generated. Since the location at which the great stress is generated is not made of the second material formed by a method by material lamination, the rotor blade resistible to stress generated upon high-speed rotation can be provided.

Moreover, in the rotor blade according to the sixth aspect, the second material forming the second portion has a smaller specific weight than the specific weight of the first material forming the center portion and the first portion. With this configuration, the weight of the entirety of the blade can be decreased. As a result, the level of the stress generated at the connection portion between the center portion and the blade upon high-speed rotation can be decreased, and the rotor blade more resistible to high-speed rotation can be provided.

(Seventh Aspect) A rotor blade of a vacuum pump according to the seventh aspect includes a center portion and a blade radially extending from the center portion. In this rotor blade, the blade has a first portion and a second portion. The first portion is a portion extending from a connection portion between the blade and the center portion by a predetermined length. The second portion is a portion extending from a tip end of the first portion to a tip end of the blade. The center portion and the first portion are made of a first material. The second portion is made of a second material having a lower 0.2% proof stress than that of the first material.

In the rotor blade of the vacuum pump according to the seventh aspect, the center portion and first portion of the rotor blade are made of the same first material. That is, the center portion, the connection portion between the center portion and the blade, and the first portion of the blade extending from the connection portion are formed using the same first material. On the other hand, the remaining portion of the blade, i.e., the second portion extending from the tip end of the first portion to the tip end of the blade, is formed using the second material having a lower 0.2% proof stress than that of the first material. Thus, in the rotor blade according to the seventh aspect, the second portion made of the second material having a lower 0.2% proof stress does not include the connection portion between the center portion and the blade, at which great stress is generated. Since the location at which the great stress is generated is not made of the second material having a lower 0.2% proof stress, the rotor blade resistible to stress generated upon high-speed rotation can be provided. Moreover, since the second portion can be made of the second material having a lower 0.2% proof stress than that of the first material, the degree of freedom in selection of the second material used for forming the second portion can be enhanced.

(Eighth Aspect) A vacuum pump according to the eighth aspect includes the rotor blade according to the sixth or seventh aspect. The rotor blade according to the sixth or seventh aspect is resistible to high-speed rotation, and therefore, the vacuum pump according to the eighth aspect is configured so that a pumping capacity can be enhanced by high-speed rotation of the rotor blade.

What is claimed is:

1. A method of manufacturing a rotor blade provided in a vacuum pump and having a center portion and a blade radially extending from the center portion, comprising:
forming, using a first material, the center portion and a first portion of the blade extending from a connection portion between the blade and the center portion by a predetermined length; and
forming, using a second material laminated and formed on the first material, a second portion of the blade extending from a tip end of the first portion to a tip end of the blade.

2. The method of manufacturing the rotor blade according to claim 1, further comprising:
laminating and forming the second material at a location corresponding to the first portion on the first material; and
forming the center portion and the first portion by cutting the first material and forming the second portion by cutting the second material.

3. The method of manufacturing the rotor blade according to claim 1, further comprising:
forming the center portion and the first portion by cutting the first material; and
laminating and forming the second portion made of the second material from the tip end of the first portion formed by cutting.

4. The method of manufacturing the rotor blade according to claim 1, wherein
the predetermined length of the first portion is determined based on a size of an area where a predetermined level of stress or more is generated at the connection portion.

5. The method of manufacturing the rotor blade according to claim 1, wherein
the second material is laminated on the first material by additive manufacturing.

6. A rotor blade of a vacuum pump, comprising:
a center portion; and
a blade radially extending from the center portion,
wherein the blade has a first portion extending from a connection portion between the blade and the center portion by a predetermined length and a second portion extending from a tip end of the first portion to a tip end of the blade,
the center portion and the first portion are made of a first material, and
the second portion is made of a second material having a smaller specific weight than that of the first material.

7. A rotor blade of a vacuum pump, comprising:
a center portion; and
a blade radially extending from the center portion,
wherein the blade has a first portion extending from a connection portion between the blade and the center portion by a predetermined length and a second portion extending from a tip end of the first portion to a tip end of the blade,
the center portion and the first portion are made of a first material, and
the second portion is made of a second material having a lower 0.2% proof stress than that of the first material.

8. A vacuum pump comprising
the rotor blade according to claim 6.

9. A vacuum pump comprising
the rotor blade according to claim 7.
